(19) United States
(12) Patent Application Publication
(10) Pub. No.: US 2002/0135806 A1
(43) Pub. Date: Sep. 26, 2002

(54) Web page printing program, computer-readable medium, web page display, and web page printing method

(76) Inventor: Masumi Yoshino, Nagano (JP)

Correspondence Address: MATTINGLY, STANGER & MALUR, P.C., 1800 DIAGONAL ROAD, SUITE 370, ALEXANDRIA, VA, 22314, US

(21) Appl. No.: 10/102,670

(22) Filed: Mar. 22, 2002

(30) Foreign Application Priority Data
Mar. 23, 2001 (JP) 2001-084607
Jan. 11, 2002 (JP) 2002-004314

(51) Int. Cl. B41F 1/00; G06F 15/00

(52) U.S. Cl. 358/1.15

(57) ABSTRACT

A Web page printing program is prepared so that it is executed when a Web browser is executed and that when the user performs predetermined operation, the Web page printing program acquires the image data concerning only the portion of the Web page accessed by the user using the Web browser, displayed in a browser window at the point in time and prints based on the image data.

The present application is based on Japanese Patent Applications No. 2001-084607 and 2002-004314, which are incorporated herein by reference.

### BACKGROUND OF THE INVENTION

1. Field of the Invention

This invention relates to a Web page printing program for printing a Web page, a computer-readable medium recording such a Web page printing program, a Web page display for displaying And printing a Web page, and a Web page printing method for printing a Web page.

2. Description of the Related Art

As known, to view a Web page (WWW page) on the Internet, software called a Web browser (WWW browser) is used.

Every existing Web browser enables the user to easily view a Web page. However, if a Web page is printed with any Web browser, the portion to be printed is printed across pages or an unnecessary portion is also printed.

### SUMMARY OF THE INVENTION

It is therefore an object of the invention to provide a Web page printing program that can give a computer a function of printing a Web page only in any desired range, a computer-readable medium recording such a Web page printing program, and a Web page display and a Web page printing method for making it possible to print a Web page only in any desired range.

To the end, according to the invention, there is prepared a Web page printing program, in association with different programs installed in a computer including display and an input unit, for causing the computer to operate as an apparatus comprising:

range recognition means for recognizing the print range desired by a user, of a web page displayed on the display based on the user's operating contents of the input unit; and

print data preparation means for preparing print data for a printer to print the Web page only in the range recognized by the range recognition means.

Since the Web page printing program can provide the computer with the function of printing Web page only in the range desired by the user, the environment in which the Internet and the printer can be used more effectively can be provided for the user of the Web page printing program.

To realize the Web page printing program of the invention, a Web browser function may be contained in the Web page printing program and the Web page printing program may be prepared so as to operate in association with the OS, the Web browser, and the printer driver.

To realize the Web page printing program as a program operating in association with the Web browser, the Web page printing program can be prepared so that the print data preparation means becomes means for preparing the print data based on the image data used to display the Web page on the display.

The Web page printing program may be prepared so that the print data preparation mean becomes means having the function of printing the Web page in the range recognized by the range recognition means in a predetermined range of paper. In other words, the Web page printing program may be able to print information in the user-specified range with the size adjusted.

The Web page printing program may be prepared so that the range recognition means becomes means for recognizing the portion in a browser window, of the Web page displayed on the display as the print range desired by the user.

A computer-readable medium of the invention records the Web page printing program of the invention, and a Web page display of the invention has a similar function to that of the computer in which the Web page printing program of the invention is executed. Therefore, according to the computer-readable medium of the invention or the Web page display of the invention, the environment in which the Internet and the printer can be used more effectively can also be provided for the user. A Web page printing method of the invention can also be used to print a Web page only in any desired range. Thus, according to the Web page printing method of the invention, the environment in which the Internet and the printer can be used more effectively can also be provided for the user.

### BRIEF DESCRIPTION OF THE DRAWINGS

In the accompanying drawings:

FIG. 1 is a schematic representation of the use mode of a Web page printing program according to one embodiment of the invention;

FIG. 2 is a hardware block diagram of a computer in which the Web page printing program according to the embodiment of the invention can be installed;

FIG. 3 is a flowchart to describe the function of the Web page printing program according to the embodiment of the invention;

FIG. 4 is a schematic representation of a print command acquiring dialog box displayed by the Web page printing program according to the embodiment of the invention;

FIG. 5 is a schematic representation of a print condition setting dialog box displayed by the web page printing program according to the embodiment of the invention;

FIG. 6 is a drawing to describe how to use the Web page printing program according to the embodiment of the invention;

FIG. 7 is a drawing to describe how to use the Web page printing program according to the embodiment of the invention; and

FIGS. 8A and 8B are schematic representations of the print result of the Web page printing program according to the embodiment of the invention.

### DETAILED DESCRIPTION OF THE PREFERRED EMBODIMENTS

Referring now to the accompanying drawings, there is shown a preferred embodiment of the invention.

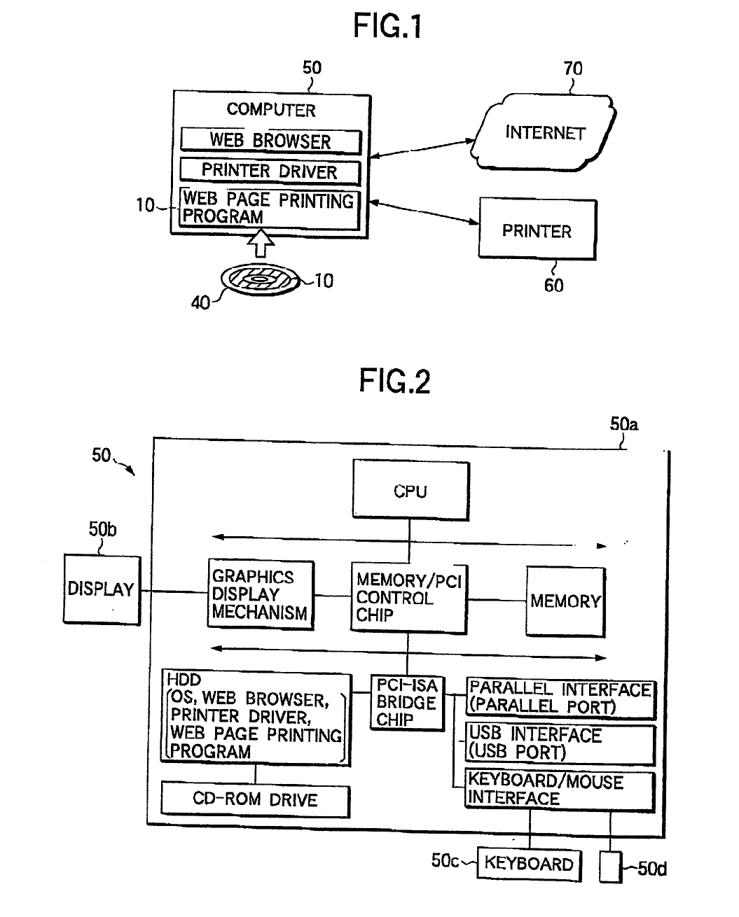

To begin with, an outline of a Web page printing program 10 according to one embodiment of the invention will be discussed with reference to FIGS. 1 and 2.

As schematically shown in FIG. 1, the Web page printing program 10 according to one embodiment of the invention is a program installed in a general computer 50 (that can access Internet 70 and is connected to an available printer 60) in which an operating system (OS), a Web browser, a printer driver, and the like are installed. That is, the Web page printing program 10 is installed in the computer 50 which comprise a main unit 50a having a CPU, a memory/PCI control chip, memory, a graphics display mechanism, a PCI-ISA bridge chip, an HDD, a CD-ROM drive, a parallel interface (parallel port), a USB interface (USB port), a keyboard/mouse interface, and the like, a display 50b connected to the graphics display mechanism, a keyboard 50c, a mouse 50d, and the like and is connected to the printer 60 (not shown) through the parallel interface or the USB interface, for example, as shown in FIG. 2.

To provide the Web page printing program 10 for the user, a record medium such as a CD-ROM 40 is distributed or the program is downloaded from a server on the Internet 70.

Tho Web page printing program 10 is a program provided for the user together with an installer and installed in the computer 50 by the installer so that execution of the printing program is started when the computer 50 is started (so-called resident program). In other words, the Web page printing program 10 is a program used in such a manner that it is started when the OS is started.

Then, the function of the Web page printing program 10 will be discussed specifically.

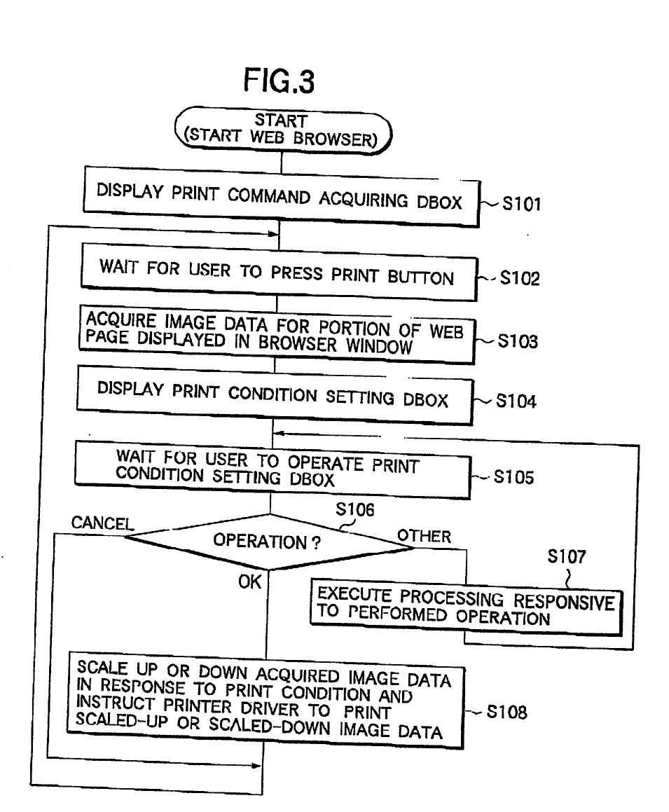

The started Web page printing program 10 acquires the program name of the used Web browser from the OS and then starts processing of monitoring starting of the Web browser (starting of execution of the program with the acquired program name). When the Web page printing program 10 detects the Web browser being started, it starts the process shown in FIG. 3.

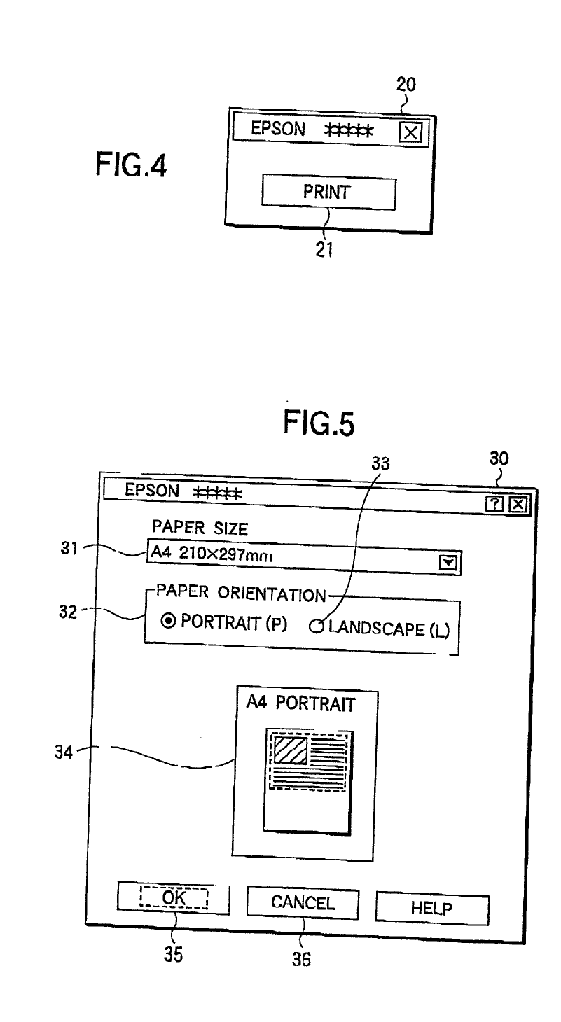

That is, the Web page printing program 10 first displays a print command acquiring dialog box 20 (described as DBOX in FIG. 3) on the display 50b of the computer 50 on which a Web browser window (browser window) is displayed (step S101). The print command acquiring dialog box 20 is a dialog box comprising a PRINT button 21, as shown in FIG. 4.

Then, the Web page printing program 10 waits for the PRINT button 21 to be pressed (step S102). When the Web page printing program 10 recognizes that the PRINT button 21 is pressed (YES at step S102), it acquires the image data concerning only the portion of the Web page accessed by the user (viewer) using the Web browser, displayed in the browser window at the point in time (RGB data used to display the Web page on the display 50b) (step S103).

At step S103, the Web page printing program 10 acquires the image data from the OS (display driver)

Then, the Web page printing program 10 displays a print condition setting dialog box 30 (step S104).

As shown in FIG, 5, the print condition setting dialog box 30 displayed at step S104 is a dialog box comprising a paper size setting drop-down list box 31 for setting the paper size, two radio buttons 32 and 33 for setting the print orientation, an illustration display area 34 for displaying an illustration indicating setup conditions, an OK button 35, a CANCEL button 36, etc.

After displaying the print condition setting dialog box 30, the Web page printing program 10 waits for the user to operate the print condition setting dialog box 30 (step S105). If the operator performs any operation other than pressing the CANCEL button 36 or the OK button 35 (other at step S106), the Web page printing program 10 executes processing responsive to the operation performed (step S107). That is, at step S107, the Web page printing program 10 performs processing of displaying another paper size in the paper size setting drop-down list. box 31, processing of changing the display node of the radio button 32, 33 concerning the paper orientation, processing of changing the contents of the illustration display area 34, or the like. Then, the Web page printing program 10 returns to step S105 and again waits for the user to operate who print condition setting dialog box 30.

If the CANCEL button 36 is (CANCEL at steps S105 and S106), the Web page printing program 10 erases (not shown) the print condition setting dialog box 30 and then returns to step S102 and waits for the user to press the PRINT button 21.

If the OK button 35 is pressed (OK at steps S105 and S106), the Web page printing program 10 erases (not shown) the print condition setting dialog box 30 and scales up or down the image data acquired at step S103 so that the longitudinal or lateral size matches the longitudinal or lateral size of the printable area of print paper, and then instructs the printer driver to print the scaled-up or scaled-down image data (step S108).

Specifically, at step S108, if value Ri resulting from dividing the longitudinal length of the acquired image data (the number of dots) by the lateral length (the number of dots) is equal to or greater than value Rp resulting from dividing the longitudinal length of the printable area by the lateral length (Rp≈1.4 if the print orientation is PORTRAIT; Rp≈0.7 if the print orientation is LANDSCAPE), the Web page printing program 10 changes the resolution of the image data (the number of dots par Unit length) so that the lateral length matches the lateral length of the printable area. That is, the Web page printing program 10 prepares image data of such a resolution based on the acquired image data. The Web page printing program 10 instructs the printing driver to print the image data according to a similar procedure to that of a general application program. On the other hand, if Ri is than less Rp, the Web page printing program 10 changes the resolution of the image data so that the longitudinal length matches the lateral length of the printable area, and instructs the printer driver to print the image data.

Then, the Web page printing program 10 returns to step S102 and waits for the user to press the PRINT button 21.

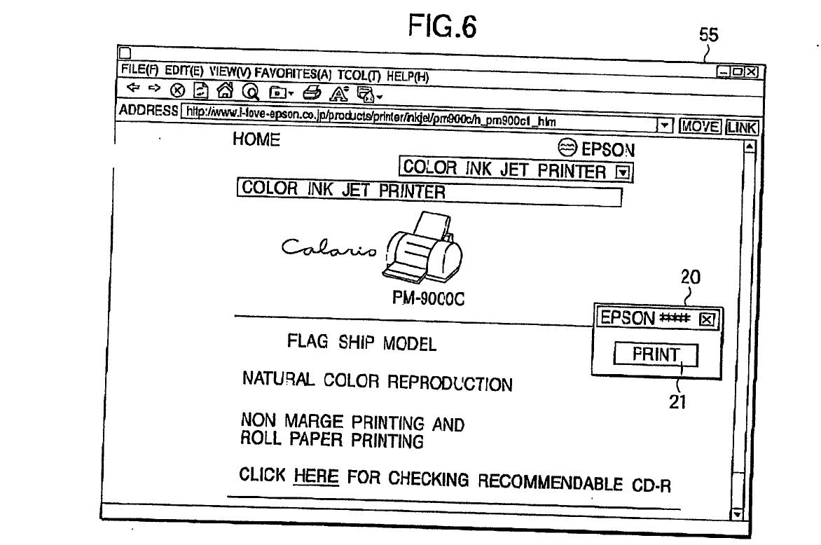

How to use the Web page printing program 10 according to the embodiment will be discussed specifically by taking the case where when accessing the Web page of the contents shown in FIG. 6, the user wants to print the Web page with the top and bottom cut as an example.

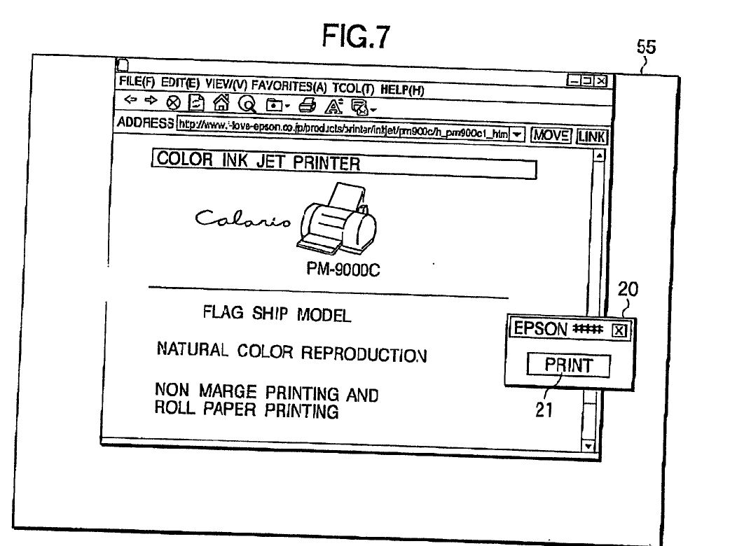

In this case, the user uses the mouse 50d to change the size of the browser window, etc., whereby the state in which only the portion to be printed is displayed in the browser window is formed, as shown in FIG. 7. In the figure, a solid frame 55 indicates the fringe of the screen of the display 50b of the computer 50.

The user uses the mouse 50d to press the PRINT button 21 on the print command acquiring dialog box 20. As the user press the button, the Web page printing program 10 acquires the image data of the image displayed in the browser window. Since the print condition setting dialog box 30 is displayed on the display 50b, the user changes the paper size or the paper orientation as required and then presses the OK button 35.

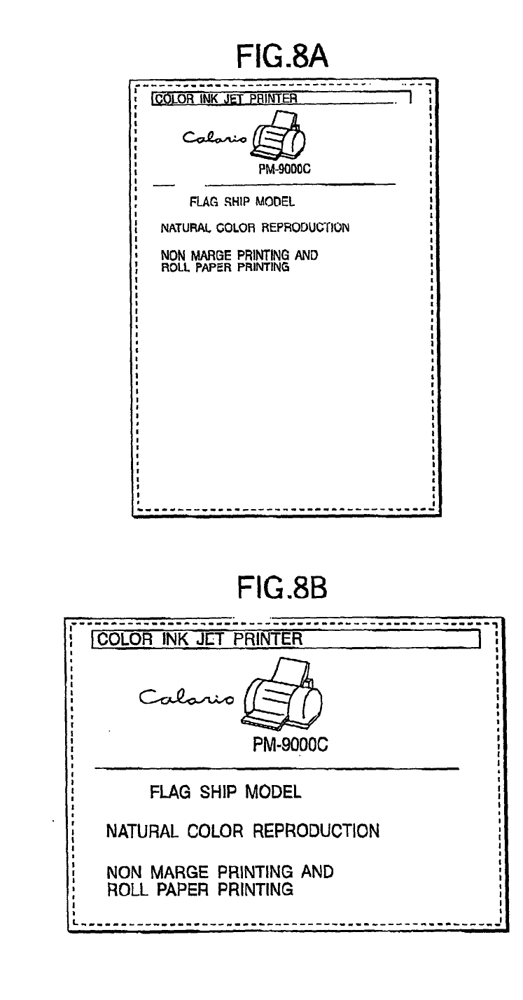

When detecting the OK button 35 being pressed, the Web page printing program 10 instructs he printer driver to draw the image responsive to the acquired image data in paper specified for use in the size responsive to the size of the paper. Therefore, if the user selects PORTRAIT as the print orientation after pressing the PRINT button 21 in the state in FIG. 7, the printer 60 prints out printed matter as shown in FIG. 8A. If the users selects LANDSCAPE as the print orientation, the printer 60 prints out printed matter as shown in FIG. 8B.

Thus, the Web page printing program 10 according to the embodiment can provide the computer 50 with the function of printing a Web page only in any desired range, so that the environment in which the Internet 70 and the printer 60 can be used more effectively can be provided for the user of the Web page printing program 10.

<Modifications>

Various modifications of the Web page printing program 10 according to the embodiment are possible. For example, although the Web page printing program 10 according to the embodiment acquires the image data in the specified range from the display driver and prints the image data, it maybe prepared so as to interpret and print HTML data defining the drawing contents in the specified range. In other words, the Web page printing program 10 may be provided by giving the Web browser the function or interpreting and printing HTML data defining the drawing contents in the specified range.

The Web patio printing program 10 may be modified so as to acquire the image data in the specified range from the Web browser and prints the image data.

With the Web page printing program 10 according to the embodiment, the size of the browser window is changed for specifying the print range, but the Web page printing program 10 may be prepared so as to enable to the user to specify the print range by clicking and dragging.

The Web page printing program 10 may be prepared so as to wait for the user to press specific keys, such as function key and control key and P key, in place of waiting for the user to press the PRINT key 21 at step S102 as the print command acquiring dialog box 20 is displayed.

A dedicated apparatus having a similar function to that of the computer 50 in which the Web page printing program 10 is installed may be configured based on the technology used for the Web page printing program 10.

According to the invention, it is made possible to print a Web page only in any desired range, so that the environment in which the Internet and the printer can be used more effectively can be provided for the user.

This invention should not be limited to the mode of carrying out this invention and the embodiments described above. Various modifications can be included in this invention within a range which can be easily realized by those skilled in the art without departing from thy spirit of the scope of claim.

What is claimed is:

1. A Web page printing program being installed in a computer including a display and an input unit, said program, in association with different programs installed in the computer, for causing the computer to operate as an apparatus comprising:
range recognition means for recognizing a print range desired by a user, of a Web page displayed on the display based on the user's preparation contents of the input unit; and
print data preparation means for preparing print data for a printer to print the Web page only in the print range recognized by the range recognition means.

2. A Web page printing program according to claim 1, wherein the different programs are an operation system, a Web browser, and a printer driver.

3. A Web page printing program according to claim 2, wherein the print data preparation means prepares the print data based on image data used to display the Web page on the display.

4. A Web page printing program according to claim 1, wherein the print data preparation means has a function of printing the Web page in the range recognized by the range recognition means in a predetermined range of paper.

5. A Web page printing program according to claim 1, wherein the range recognition means recognizes a portion in a browser window, of the Web page displayed on the display as the print range desired by the user.

6. A computer-readable medium recording a Web page printing program being installed in a computer including a display and an input unit,
the Web page printing program, in association with different programs installed in the computer, for causing the computer to operate as an apparatus comprising:
range recognition means for recognizing a print range desired by a user, of a Web page displayed on the display based on the user's operating contents of the input unit; and
print data preparation means for preparing print data for a printer to print the Web page only in the print range recognized by the range recognition means.

7. A computer-readable medium according to claim 6, wherein the range recognition means recognizes a portion in a browser window, of the Web page displayed on the display as the print range desired by the user.

8. A Web page display comprising:
a display;
an input unit;
Web page display controls means for displaying a specified Web page on the display;
range recognition means for recognizing a print range desired by a user, of a Web page displayed on the display based on the user's operating contents of the input unit; and
print data preparation means for preparing print data for a printer to print the Web page only in the range recognized by the range recognition means.

9. A Web page display according to claim 8, wherein the Web page display control means displays a window whose size can be changed on the display and displays the specified Web page the window and wherein
the range recognition means recognizes a portion in the window, of the Web page displayed on the display as the print range desired by the user.

10. A Web page printing method of printing a Web page, said method comprising:
a command acquisition step of acquiring from a viewer of a Web page a command concerning a print range of the Web page desired by the viewer; and
a print data preparation step of preparing print data for a printer to print the Web page only in the print range indicated by the command acquired in said command acquisition step.

11. A Web page printing method according to claim 10, wherein said command acquisition step is to recognize the actually displayed portion of the Web page on the display as the print range desired by the viewer.
